(19) United States
(12) Patent Application Publication
(10) Pub. No.: US 2008/0122750 A1
(43) Pub. Date: May 29, 2008

(54) PLASMA DISPLAY DEVICE

(76) Inventor: MICHITAKA OHSAWA, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/747,420

(22) Filed: May 11, 2007

(30) Foreign Application Priority Data
Nov. 27, 2006 (JP) 2006-317954

(51) Int. Cl. G09G 3/28

(52) U.S. Cl. 345/67; 345/60

(57) ABSTRACT

The present invention realizes, in a plasma display device with two systems (X and Y systems) of sustain circuits integrated, a stable drive and improvement of the service life. In the present invention, X-electrodes are set at the ground potential, and Y-electrodes have, in a reset period, an application of reset pulses having a positive polarity and a negative polarity and, in a sustain period, an application of sustain pulses having the positive polarity and the negative polarity are applied and in a sustain period. Address pulses are applied to the address electrodes in an address period. At least either in the reset period or in the sustain period, pulse signals are applied to the address electrodes. Then, the level of the pulse signal is higher than a level of the address pulse.

### CLAIM OF PRIORITY

The present application claims priority from Japanese Application JP 2006-317954 filed on Nov. 27, 2006, the content of which is hereby incorporated by reference into this application.

### BACKGROUND OF THE INVENTION

1. Field of the Invention

The present invention relates to plasma display devices, and, more particularly, to the present invention relates to a plasma display device push-pull driving a plasma display panel from one side (for instance, a Y-electrode side) when sustain-discharging.

2. Description of the Related Art

A three-electrode system surface discharge structure of AC drive type plasma display panel (hereinafter abbreviated as “PDP”) that has been frequently used at present includes a plurality pairs of a scan sustain discharge electrode (hereinafter abbreviated as “Y-electrode”) and a sustain electrode (hereinafter abbreviated as “X-electrode”) which are formed linearly in the lateral direction of a screen (row direction), and a plurality address electrodes (hereinafter abbreviated to “A-electrodes) that are formed linearly in a longitudinal direction (column direction) of the screen. Y-electrode terminals each as a scan electrode are arranged on one side in the row direction, and X-electrode terminals each as a sustain electrode are arranged on the other side.

In a display device (hereinafter called a “Plasma Display Device”) using the PDP, during sustain discharging, the PDP is generally driven from the Y-electrode side and then from the X-electrode side, that is, push-pull drive is alternately performed (Refer to, for instance, JP-A-2006-139252 (Document 1)). Here, the drive system is referred to as “Both-side drive system”.

However, the push-pull drive driven from the both sides is necessary for a Y-circuit board mounting thereon a Y-drive section (including a scan circuit and a Y-sustain circuit) for driving the PDP from the Y-electrode side and an X-circuit board mounting an X-sustain circuit for driving the PDP from the X-electrode side. Accordingly, it is difficult to further reduce the cost.

For instance, JP-A-2005-338839 (Document 2) and “Byung-Gwon Cho, et al. “New Cost Effective Driving Method Based on Vt Close Curve Analysis in AC Plasma Display Panel” IDW/AD '05 Digest, PP. 465-468, 2005” (Document 3) disclose such a technology that the X-electrode side is grounded and the PDP is push-pull driven from the Y-electrode side (hereinafter, referred the drive to as “one-side drive”). If the PDP is one-side driven from the Y-electrode side, the X sustain circuit that has conventionally been necessary will be unnecessary, which can reduce costs.

### SUMMARY OF THE INVENTION

In the one side drive in which the X-electrode is grounded to be set at the reference potential and the PDP with the three-electrode system surface discharge structure is push-pull driven from the Y-electrode side, a drive waveform of each electrode (Y-electrode and A-electrode) is basically similar waveform to the conventional drive waveform of the both sides drive as illustrated in Document 2 (FIG. 7) and Document 3 (FIG. 5). However, with the grounded X-electrode, the drive waveform is designed so that Y-electrode potential and X-electrode potential are equal to each other. That is, comparing FIG. 5 in Document 3 with FIG. 4 of Document 1, it is apparent that the Y-potential shifts to a negative side by the potential applied in a section in which a positive potential is applied to the X electrode when driving both sides. For instance, in a sustain period, positive and negative pulses are applied to the Y electrode with the ground potential as a reference.

The drive waveform of the A-electrode has a considerable difference between both drive systems. For instance, as illustrated in FIG. 5 of Document 3, in a rest period, a positive voltage Va is applied to the A-electrode in response to an rising period of a positive reset pulse (initialization pulse) added to the Y-electrode. Also, in the sustain period, the positive voltage Va is applied to the A-electrode in response to a positive sustain pulse of the Y-electrode. Hereinafter, the positive voltage pulse applied to the A-electrode is referred to as a “positive pulse” for explanation. The voltage Va is equal to a voltage of an address pulse applied to the A-electrode in an address period. Thus, in the one-side drive, a description will be made of reasons for applying the voltage Va to the A-electrode in the reset and the sustain period.

When applying the positive pulse to the A-electrode in the rising period of the reset period, a potential difference between the A-electrode and the Y-electrode decreases and a potential difference between the X-electrode and the Y-electrode exceeds a discharge inception voltage earlier than a potential difference between the A-electrode and the Y-electrode. Thus, a weak discharge occurs between the X-electrode and the Y-electrode, which forms priming particles. Then, in the state where the priming particles are formed, the potential difference between the A-electrode and the Y-electrode exceeds the discharge inception voltage. A discharge delay between the A electrode and the Y electrode is reduced by the priming particles and a strong discharge does not occur. Then desired quantity of wall charges is formed by the weak discharge. That is, a desired quantity of wall charges can be formed in the rising period regardless of a previous lighting state (lighting or non-lighting) of each cell. Thus, the weak discharge occurs even in a falling period of the reset period, resetting over all cells can be definitely performed. A stable reset operation is particularly important in the one-side drive system. Setting the A-electrode to a positive voltage can lower the speed at which the positive charges (ion particles) formed by the weak discharge which occurs in the rising period go toward the A-electrode. The weak discharge can reduce degradation of the fluorescent substance due to a collision of the ion particles with a fluorescent substance for covering the A-electrode. The degradation of the fluorescent substance results in lowering of the brightness.

Next, a description is made of positive pulse application to the A-electrode in the sustain period. In the one-side drive system, as illustrated in FIG. 5 of the document 3, the Y-electrode is alternately changed to the positive voltage and the negative voltage with the ground potential as the reference potential in the sustain period. Then, if the potential of the A-electrode is equal to the reference potential of the X-electrode, wall charges in response to a polarity of a sustain pulse of the Y-electrode adhere to the A-electrode (generally, in the both-side drive, the sustain pulse is a positive voltage to the potential of the A-electrode, and thus the positive charges are adhered to the A-electrode). Consequently, the discharge between the A-electrode and the Y-electrode is easily generated by polarity changes of the sustain pulse. The ion particles are formed by the sustain discharge generated by application of the positive sustain pulse and are attracted to the A-electrode side. As a result, the fluorescent substance is easily degraded by ion impact. When a negative sustain pulse is applied, the degradation of the fluorescent substance by the ion impact is reduced because the A-electrode is a positive potential to the Y-electrode.

Accordingly, when a positive voltage pulse is applied to the A-electrode in response to the positive sustain pulse of the Y-electrode, a voltage difference between the Y-electrode and the A-electrode when the positive sustain pulses are applied is decreased and then the discharge between the A-electrode and the Y-electrode will not occur. Also, at that time, the number of the positive charges adhering to the A-electrode is decreased, and the discharge between the A-electrode and the Y-electrode by polarity inversion of the sustain pulses is reduced. That is, a stable sustain discharge can be realized by the application of the positive pulse to the A-electrode. Also, the application of the positive pulses reduces the degradation of the fluorescent substance by the ion impact.

As described above, a voltage value of the positive pulse of the A-electrode which is applied in the rising period of the reset period and in the sustain discharge period is equal to the address pulse voltage (or referred to as an address voltage) Va which is applied to the A-electrode in the address period, according to the documents 2 and 3. However, to achieve the effects by application of the positive pulse to the A-electrode when one-side driving, that is, a secure reset, a stable discharge, reduction of the degradation of the fluorescent substance by the ion particles, it is preferable to set the positive pulse voltage higher than the address pulse voltage Va.

The present invention provides the preferred technology for operating the one-side drive type plasma display device stably and improving the service life.

In the one-side drive type plasma display device according to the present invention in which the X-electrode is grounded; the reset pulse having the positive and the negative polarity is applied to the Y-electrode in the reset period; and the sustain pulse having the positive and the negative polarity in the sustain period, a pulse signal is applied to the address electrode in either of the reset period or in the sustain period and a level of the signal is set higher than a level of the address pulse applied to the address electrode.

The pulse signal is applied in response to the positive reset pulse applied to in the reset period and/or the positive sustain pulse applied to the Y-electrode in the sustain period.

Also, an address drive circuit for applying the pulse signal to the address electrode is floated, which supplies a voltage for setting a voltage level of the pulse signal to the address drive circuit.

With the present invention, it is possible to stably operate the one-side type plasma display and improve a service life of the device.

### BRIEF DESCRIPTION OF THE DRAWINGS

FIG. 1 is a schematic view of a main section of a typical PDP drive waveform in a one-side drive system according to an embodiment of the present invention;

FIG. 2 is a schematic view of a PDP drive section in a plasma display device according to the embodiment; and

FIG. 3 is a schematic view illustrating a discharge state in a discharge cell.

### DETAILED DESCRIPTION OF THE PREFERRED EMBODIMENT

The best mode for carrying out the present invention is described in detail by referring to the drawings. In each view, the components having common functions are denoted by the same reference numerals, and, for the elements that have been described once, the duplicated description is omitted.

In the one-side type plasma display device according to this embodiment, a level of a pulse applied to an A-electrode in at least either in the reset period or in the sustain period is higher than a level of an address pulse applied to an address electrode in an address period. To achieve the objective as described above, in this embodiment, a whole of an address circuit including an A-electrode driving power source is floated, and a variable power source for generating a power pulse is connected to a virtual ground (hereinafter abbreviated as “GND”) of the whole of the address circuit (hereinafter referred to as “floating address drive section”). The embodiment describes the reasons why that the configuration as described above is employed. An upper limit of a voltage that can be applied to the A-electrode is generally an address pulse voltage Va that the address circuit can output. It is normally difficult to apply an ideal voltage (a voltage higher than the address pulse voltage Va) in the one-side drive of the PDP.

This is because a power supply voltage applied to the address circuit directly affects the loss of the address circuit. That is, an increment of the power supply voltage increases the loss based on a square of the increment. In the present products procurable from the market, the power supply voltage of about 60 to 75V is supplied to the address circuit. However, heat radiation of an address IC forming the address circuit requires considerable effort and cost even when the voltage at such voltage level as described above is supplied. To solve the problem, in the general design technique generally employed, the power voltage of the address circuit with a high operating frequency is made as smaller as possible within the range where the address discharging is stabilized, and therefore the power supply voltage is set in the range from about 60 to 75 V as described above. Thus, due to the heat loss of the address circuit, when one-side driving, it is difficult to raise the positive pulse voltage applied to the A-electrode up to a voltage higher than the address voltage Va in the rising period and in the sustain period of the reset period.

In the embodiment of the present invention, as described above, the address circuit is configured as a floating address drive section and the virtual ground of the address circuit is connected to a variable power source generating power pulses. With the configuration, In the rising period of the reset period and the sustain period in the one-side drive system, it is possible to generate pulses each with a predetermined pulse width and having the voltage Va applied to all A-electrodes in the floating address drive section and also, to synchronize with the pulse to generate the power pulse with the predetermined pulse width in the variable power source and then superimpose the power pulse on the virtual GND of the floating address drive section. By properly setting the voltage of the superimposed power pulse of the variable power source, it is possible to apply a pulse having a suitable desired-voltage to the A-electrode, which is higher than the conventional address pulse voltage Va.

The embodiment of the present invention is described in detail with reference to the drawings.

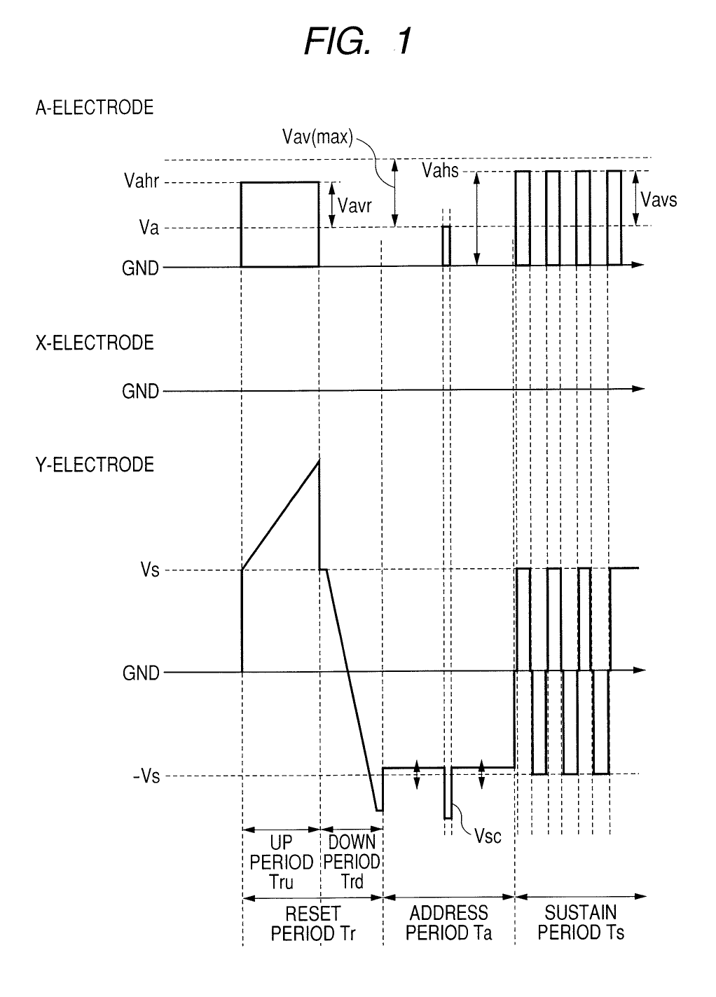

FIG. 1 is a view schematically illustrating a main portion of a typical PDP drive waveform in the one-side drive system according to the embodiment, and the reset period is mainly illustrated in this figure. The drive waveform illustrated in FIG. 1 is the same as that illustrated in FIG. 5 in the document 3. However, the pulse voltages applied to the A-electrode are different from each other.

The PDP structure is based on the three-electrode system surface discharge structure which is generally used currently. Namely, the X-electrode and the Y-electrode are arranged in parallel with a front plate of the PDP, and the A-electrode for addressing is arranged opposite to the X-electrode and the Y-electrode and orthogonal to the electrodes on a back plate of the PDP.

As illustrated in FIG. 1, one subfield period is divided into three periods, a reset period Tr, an address period Ta, and a sustain period Ts. The reset period Tr is divided into a rising period Tru and a falling period Trd.

The drive waveform illustrated in FIG. 1 is basically identical to that shown in FIG. 7 of the patent document 2 and FIG. 5 of the non-patent document 1. However, in this embodiment of the present invention, the pulse voltages applied to the A-electrode in the rising period Tru of the reset period is different from that applied to the A-electrode in the sustain period Ts. Since the details of the drive waveform are described in the documents 1 and 3, only the drive waveform is briefly described herein.

As illustrated FIG. 1, in the rising period Tru of the reset period, different from the conventional case (Refer to FIG. 5 of the document 3), a voltage Vahr exceeding the address voltage Va is applied to the A-electrode (hereinafter, the pulse is referred to as “address reset pulse” and abbreviated as “A-reset pulse”). Here, Vahr=Va+Vavr, where a subscript r means “reset”; Va is equal to a voltage value of the address pulse; and Vavr is a change (increment) from the voltage value Va.

Firstly, in the Y-electrode, the applied voltage is transitionally increased within a voltage range where a discharge will not be generated (in order to reduce time, the method is adopted although it is possible to simply increase the voltage with an inclination). Here, the voltage is raised up to the voltage Vs. Then, in a range where a discharge begins in certain cells, the voltage value is gradually increased with an inclination to generate a feeble discharge and then form wall charges. A peak value of the voltage is set at a voltage value at which all cells in the PDP fully exceed the discharge inception voltage.

In the falling period Trd of the reset period, the applied voltage to the Y-electrode is transitionally decreased to the voltage Vs with the A-electrode as the GND potential (reference potential), and then the voltage value is gradually decreased towards a negative voltage lower than a voltage −Vs to generate feeble discharge. With the functional configuration as described above, by partly erasing the wall charges formed at the Y-electrode, the X-electrode, and the A-electrode, respective wall charges are adjusted so that the address discharges easily occur in the next address period.

In order to select a cell to be lighted (to be illuminated) in the address period Ta, a scan pulse (negative voltage pulse) Vsc lower than the voltage −Vs is applied to a scan Y-electrode and also the address pulse (pulse voltage Va) is applied to the A-electrode in response to a lighting cell. A non-scan Y-electrode does not generate a discharge between the A-electrode and the Y-electrode. For instance, the non-scan Y-electrode is biased at a negative voltage near the voltage −Vs, and the A-electrode in response to a non-lighting cell is set to the reference potential (GND).

In the next sustain period Ts, in order to push-pull drive the Y-electrode to maintain the sustain discharge, the positive sustain pulse with the voltage Vs and the negative sustain pulse with the voltage −Vs are alternately applied to the Y-electrode. Then, a positive pulse (hereinafter referred to as “A-positive pulses”) synchronized with the positive sustain pulse is applied to the A-electrode. During application of the negative sustain pulses, the A-electrode is set to the reference potential. Although a voltage value of the A-positive pulse is equal to the voltage Va of the address pulse in the conventional technology (Refer to FIG. 5 of the non-patent document 1), in the embodiment, the voltage value is set at a voltage Vahs exceeding the address voltage Va. Here, Vahs=Va+Vavs. However, a subscript S means “sustain”, and Vavr is a change (an increment) from the voltage Va. The pulse (the A-reset pulse and the A-positive pulse) of the voltage Vah (Vahr and Vahs) applied to the A-electrode described above is acquired by superimposing a pulse of a voltage Vav (Vavr and Vavs) on a pulse of the voltage Va. Hereinafter, for discrimination between the pulse of the voltage Va and the address pulse in the address period, the pulse of the voltage Va is referred to as “A-basic pulse” for explanation. The A-basic pulse (voltage value Va) is generated in the floating address drive section and the power pulse (voltage value Vav) generated in the variable power source is superimposed on the A-basic pulse (details will be described later). In the description above, the voltages Vav of superimposed power pulses in the rising period Tru of the reset period and in the sustain period Ts are different from each other. That is, the voltage Vavr and the voltage Vavs are different from each other. However, it should be understood that the present invention is not limited to the configuration as described above, and various voltage values may be set in response to a preceding lighting state of each cell in the subfield. Of course, it is possible to set at the equal voltages. The voltage Vav is set at 0V in the falling period Trd of the reset period, in the address period Ta, and in the negative sustain pulse applying period of the sustain period Ts.

The embodiment relates, as illustrated in FIG. 1, to the voltage applied to the A-electrode in the rising period of the reset period, and in the sustain period. The voltage applied to the A-electrode is described in detail below.

It is preferred that a potential of the A-electrode in the rising period Tru of the reset period and in the sustain period Ts is maintained positive in order to reduce damages to the fluorescent substance by the ion impact. With the above, as disclosed in the non-patent document 1, there is an embodiment that the positive voltage is applied to the A-electrode in the rising period of the reset period and in the sustain period Ts.

The voltage value is generally set equal to the address voltage Va due to constraints in circuit. The reason is that, since the voltage applied to the A-electrode is supplied by the address circuit, it is difficult to raise the voltage up to a higher voltage than the voltage Va considering the loss and a withstand voltage of the drive IC substituting the address circuit.

Further, details are described below. In the PDP drive circuit, the address circuit is operated at the highest speed, and the number of the circuit outputs is large. Therefore, the address circuit is generally constructed with a plurality of integrated ICs. With the structure, it is not easy to radiate the heat of the circuit (specifically, address ICs).

For the reasons described above, an operating voltage of the address circuit is generally set at the lowest voltage value at which failures including a discharge fluctuation do not occur concerning the address drive. That is, in the rising period of the reset period and in the sustain period, even if it is expected that various performances and reliabilities are improved by supplying the higher voltage than the voltage Va needed for the address drive, the voltage has been suppressed at the voltage value Va of the address voltage due to the reasons above.

In order to solve the problem, as illustrated in FIG. 1, the voltage applied to the A-electrode in the rising period of the reset period and the sustain period (q voltage value of which is denoted by Vah, a voltage value in the rising period in the reset period is denoted by Vahr, and a voltage value in the sustain period is denoted by Vahs) is set at an arbitrary voltage independently of the address voltage (indicated as Va in FIG. 1). When a change (variable range) from the voltage Va is described by Vav, the formula of Vah=Va+Vav is obtained. The voltage applied to the A-electrode can be properly varied by varying the voltage Vav from 0V to a maximum value Vav (max). In FIG. 1, the voltage Vahr is different from the voltage Vahs. However, it is possible to set the voltages at an equal level. It is also possible to provide the plasma display device in which it is possible to vary the voltage applied to the A-electrode every rising period Tru of the reset period, by properly varying the voltage Vav in response to the preceding display state of the PDP. Furthermore, for instance, when developing the plasma display device using different PDPs in inch size, the address voltage most suitable for the PDP can be set by varying the voltage value Vav. In this case, it should be understood that the voltages Vahr and Vahs are also varied. Because of the feature as described above, it is possible to shorten the development period of the plasma display device.

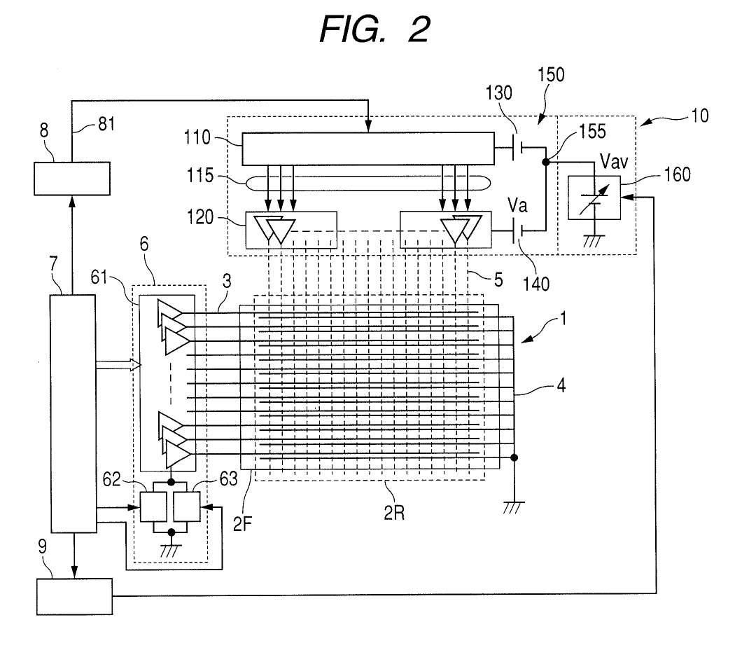

A configuration of the plasma display device having the variable power source for generating the above pulse voltage Vav to be varied, description is provided below by referring to FIG. 2.

FIG. 2 is a view schematically illustrating the PDP drive section in a plasma display device according to the embodiment.

As illustrated in FIG. 2, a PDP peripheral drive section includes a PDP 1, a Y-drive section 6, a timing control section 7, an image process section 8, a variable power control section 9, and an address drive section 10.

The PDP 1 is similar to the conventional PDP including a front plate 2F and a back plate 2R which are arranged oppositely. The front plate 2F includes a plurality pairs of the Y-electrode 3 and the X-electrode 4. The plasma display device captures emitted light through the front plate 2F. The Y-electrodes 3 and the X-electrodes 4 are formed with stripe-like laminating metal electrodes made of such a material as silver and copper, and transparent electrodes such as ITO on an inner surface side of the plate 2 of, for instance, a glass substrate. Furthermore, a dielectric (not shown and composed of glass) is arranged so as to cover the electrodes.

In FIG. 2, the sustain electrodes of the X-electrodes and the Y-electrodes are arranged in an order of Y-X, Y-X, - - - in the direction from an upper side to a lower side of the PDP. However, the arrangement in an order of X-Y, X-Y, - - - is also possible. Also, it should be understood that the embodiment is similarly applied to further arrangements in the order of X-Y, Y-X, X-Y, Y-X, - - - and in the order of Y-X, X-Y, Y-X, X-Y, - - - .

The A-electrode 5 is formed orthogonal to the Y-electrode 3 and the X-electrode 4 on the back plate 2R. In this embodiment, the X-electrode 4 is connected to the GND (reference potential) in order to perform the one-side drive system. The reference potential may be a predetermined constant potential instead of the ground potential.

The timing control section 7 generates various timing signals based on synchronous signal from a synchronous signal extraction circuit (not illustrated). The timing control section 7 generates the various kinds of timing signals, for instance, an address electrode control signal (hereinafter, referred to as “A-electrode control signal”) for controlling the A-reset pulse generation of the A-electrode in the reset period, controlling an address synchronized with a Y-electrode scan in the address period, and controlling A-positive pulse generation in the sustain period; a Y-reset control signal for instructing generation of the Y-electrode reset pulse; a scan control signal for instructing a scan, a sustain control signal for executing a sustain push-pull drive; and a power pulse control signal for instructing generation of the power pulse superimposed on the A-electrode to apply in the reset period and in the sustain period.

The Y-drive section 6 includes a scan circuit 61, a sustain circuit 62, and a Y-reset circuit 63. The scan circuit 61 scans the Y-electrode 3 based on a scan control signal from the timing control section 7. The sustain circuit 62 receives a sustain control signal from the timing control section 7 to push-pull drive the Y-electrode 3 and then maintain the sustain discharge. The Y-reset circuit 63 receives a Y-reset control signal from the timing control section 7 to generate the Y-reset pulse to apply the pulse to the Y-electrode 3.

The variable power control section 9 controls the variable power source 160 based on the power pulse control signal from the timing control section 7 so that the variable power source 160 generates power pulses with various voltage values. Specifically, the control signal is provided to the variable power source 160 when changing the A-electrode voltage in the reset period every subfield or when controlling the A-electrode voltage value in the sustain period.

An image process circuit 8 converts one field data of image data inputted to a plurality of subfield data. Then, a parallel/series conversion circuit (not illustrated) built in the image process circuit converts parallel data in the converted subfield data to serial data to provide the serial data via a transmission line 81 to the address drive section 10 based on the A-electrode control signal from the timing control section 7. In the reset period and in the sustain period, the circuit transmits control data for the A-reset pulse and control data for the positive pulse generated in the address drive section 10.

In the embodiment, in order to build the address drive section 10 with the floating structure (described later in detail), and also to reduce the number of wiring lines from the image process section 8 to the address drive section 10, a high-speed current differential transmission system with a low voltage amplitude is adopted as a mode of a signal transmission between the image process section 8 and the address drive section 10, for instance, LVDS (Low Voltage Differential Signaling), TMDS (Transition Minimized Differential Signaling), CTL (Current Transfer Logic). The number of the signal lines is reduced by high speed operations to change the signals from the parallel processing to the serial processing, which are provided to the address drive section 10 via an isolating and separating unit (for instance, a photo coupler, a high-speed pulse transformer coupling, and an electrostatic coupling, or a radio transmission are possible). The address drive section 10 converts the received serial signals to parallel signals (described later in detail) by a built-in series/parallel conversion circuit (not illustrated) contained in the interface section. Namely, by combining an interface in the high-speed current differential transmission system and the series/parallel conversion circuit arranged in the address drive section, it is possible to easily realize floating of the address drive section. In addition, it is possible to improve the complexity of noise characteristics and formation of signal lines.

The address drive section 10 is divided to a floating address drive section 150 and the variable power source 160. The floating address drive section 150 includes the interface section 110 and the address circuit 120 having a plurality of drive ICs.

The interface section 110 has an insulating separation unit (not shown) in order to float the floating address drive section 150. The insulating separation unit is electrically insulated from a peripheral circuit. The insulating unit is realized by an optical element represented by the photo coupler, a signal transmission element with an insulating function by the transformer coupling, the capacity coupling, or the radio signal transmission. However, the components are known and are not described in more detail. It is possible to insulate the floating drive section 150 from other circuits by signal transmitting using an optical fiber. The serial data inputted to the interface section 110 via the insulating unit is converted to the parallel data by the series/parallel conversion circuit (not illustrated) and then, the data is outputted as the parallel address data 115 to the address circuit 120.

The address circuit 120 includes a plurality of address drive ICs and, in the address period, synchronizes with a scan (line-scanning) by the scan circuit 61 of the Y-drive section 6 to apply the address pulse (voltage Va) to the A-electrode 5 in response to a cell to be lighted in the sustain period. The address circuit 120 also outputs, in the rising period of the reset period and in the sustain period, the A-reset pulse and the A-positive pulse to all of the A-electrodes 5 based on the A-electrode control signal from the timing control section 7.

The power source 140 supplies electric power to the address circuit 120, of which power voltage Va is generally in a range of 50-75V. When the loss of an output stage of the address circuit 120 is neglected, the address circuit 120 applies the pulse of the voltage Va to the A-electrode 5. The power source 130 is a low voltage power source for supplying electric power to a logic circuit such as the interface section 110. Generally, a voltage of the low voltage source is in a range of 3.3 to 5V.

As is clearly understood from FIG. 2, the virtual GND 155 of the floating address drive section 150 is floated and is also connected to the variable power source 160.

The variable power source 160 supplies, based on control of the variable power section 9, the power pulse with the most suitable voltage value to the floating address drive section 150 in response to a display state and/or an operation state. Specifically, in order to generate the A-reset pulse and the A-positive pulse in the rising period of the reset period and in the sustain period, the power pulse with a predetermined voltage (for instance, voltage value of Vavr or Vavs) is generated, which forms a part of the pulses and is synchronized with and superimposed on the A-basic pulse. Because of the operation described above, the power pulse generated by the variable pulse power source 160 is superimposed on the A-basic pulse outputted from the floating address drive section 150. Accordingly, the A-reset pulse (voltage value Vahr=Va+Vavr) or the A-positive pulse (voltage value Vahs=Va+Vavs) is applied to the A-electrode. It should be understood that the voltage is set at Vav=0V in a period when the power pulse is not generated.

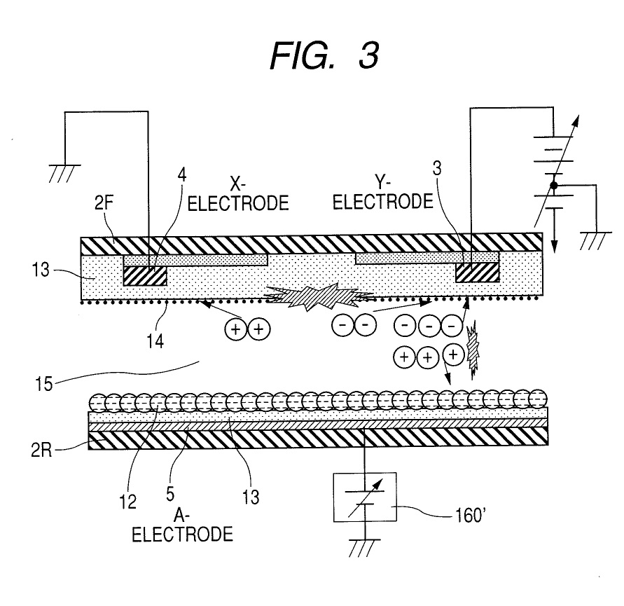

FIG. 3 is a view schematically illustrating the discharge state in the discharge cell. Components having the same functions as that of FIG. 2 are illustrated by identical numerals.

In FIG. 3, the A-electrode 5 is formed on the back plate 2R, on which the dielectric 13 is provided. Furthermore, the fluorescent substance 12 is provided on the dielectric 13. On the other hand, the Y-electrode 3 and the X-electrode 5 are formed on a surface of the front plate 2F in response to the back plate 2R, and the dielectric 13 is provided on the electrodes 3 and 5. A protective film 14 is provided on the dielectric 13 at a side of the front plate 2F. A discharge space 15 is formed in a space between the front plate 2F and the back plate 2R constructed as described above. A variable power source 160′ is added the power source 140 to the variable power source 160 in FIG. 2. In the following description, it is assumed that a power voltage of the variable power source 160 is applied to the A-electrode 5. The variable power source connected to the Y-electrode 3 indicates a drive voltage applied to the Y-electrode 3. The X-electrode 4 is fixed at the ground potential in any period. However, it is possible to fix the X-electrode at a specific potential if internal impedance of the electrode is low (if it is possible to consider as a voltage source).

A description is provided for a typical discharge state in the reset period based on FIG. 2 and by referring to FIG. 1

In FIG. 3, when gradually increasing a potential at the Y-electrode 3, discharging begins between electrodes that have exceeded a discharge inception voltage. At that time, since the voltage of the Y-electrode 3 is very slowly increased, even when the discharge has begun, a part of discharge gas encapsulated in a discharge space 15 is ionized to separate to a positive ion and an electron with a negative charge. The ionized positive ion and the electron are attracted along electric fields which are generated by voltages applied to respective electrodes. The positive ions move toward the X-electrode 4 and the A-electrode 5 that are equivalently at a negative potential to the Y-electrode, and adhere to the electrodes sandwiching the dielectric 13 and the fluorescent substance 12 (these ions are referred to as wall charges). On the other hand, the electrons are attracted to the Y-electrode 3 and similarly adhere to the Y-electrode sandwiching the dielectric 13 to form wall charges. Only the wall charges necessary to cancel electric fields are generated between the electrodes adhere to respective electrodes. That is, when the discharge has begun, the ions and electrons are immediately formed to respectively form the wall charges on the electrodes along the electric fields between the electrodes. The wall charges form electric fields opposite to the electric fields are generated between the electrodes. Consequently, the electric fields generated by the voltages applied to the electrodes are cancelled.

In the reset period, as illustrated in FIG. 1, a dull wave (or referred to as a ramp wave) reset system is generally adopted, and the Y-electrode voltage near the discharge inception voltage slowly increases in time. Accordingly, even if the electric field is temporarily cancelled due to the wall charges, the Y-electrode voltage further increases and then a new discharge will be generated. Also, the discharge will stop because the electric field by the applied voltage is cancelled by the new wall charges. The process is repeated and a feeble discharge is generated in all cells in the PDP. Then, increase of the Y-electrode voltage will stop when the wall charges are formed. Thus, in the dull wave reset, when the discharge is generated the electric field is immediately cancelled. The discharge is generated in response to the increase of the Y-electrode voltage. However, a strong discharge cannot be generated and a weak discharge will be continued. In the reset period, even if the discharge inception voltage is fluctuated from cell to cell, the discharge inception voltage of each cell is adjusted depending on the quantity of wall charges and then the discharge inception voltages of all cells are adjusted to an almost same level.

However, as illustrated in FIG. 3, the PDP with the three-electrode system surface discharge structure has three places where the discharge are generated, namely between the X-electrode 4 and the Y-electrode 3, between the Y-electrode 3 and the A-electrode 5, and between the X-electrode 4 and the A-electrode 5. In the three places between the electrodes, in order to form a potential distribution so that the discharge is not generated between the X-electrode 4 and the A-electrode 5, it is possible to actually focus on the discharges between the X-electrode 4 and the Y-electrode 3 and between the Y-electrode 3 and the A-electrode 5.

An electrode arrangement between the X-electrode 4 and the Y-electrode 3 has a surface discharge structure and an electrode arrangement between the Y-electrode 3 and the A-electrode 5 has a facing discharge electrode structure. Based on comparison of both the electrode structures, it is generally known that the facing discharge is generated more easily than the surface discharge, and also that the facing discharge is faster in discharge growth than the surface discharge. Namely, it is necessary that the discharge inception voltage and discharge intensity between the Y-electrode 3 and the A-electrode 5 are controlled to balance with the discharge between the X-electrode 4 and the Y-electrode 3. Because of the requirement described above, the variable power source 160′ is provided as an element for controlling the discharge intensity in the present embodiment. That is, when a positive high voltage is applied to the Y-electrode 3, an electric field between the Y-electrode 3 and the A-electrode 5 is weaken by further applying a positive voltage to the A-electrode 5, and it is possible to freely adjust the balance to the discharge between the X-electrode 4 and the Y-electrode 3.

It is possible to apply the discharge intensity control described above to adjustment of fluctuations in the PDP structure. That is, the variable power source 160′ may serve as a function for correcting differences in discharge characteristics such as fluctuations of materials forming the discharge cells and fluctuations in geometrical dimensions.

In addition, in order to reduce the ion impact to the fluorescent substance when a strong sustain discharge in discharge intensity is generated, it is possible to reduce the ion impact by adjusting the voltage value with the A-electrode 5 as the positive electrode. In other words, when the Y-electrode 3 is positive in the sustain period and the A-electrode 5 is also positive at the same time, the electric field from the Y-electrode 3 is strongly generated between the electrode 3 and the X-electrode 4 that is maintained at the GND potential, and then the electric field generated between the electrode 3 and the A-electrode 5 becomes relatively weak. Consequently, the positive ions generated by the sustain discharge mostly move to the X-electrode 4. Also, during the sustain period when the Y-electrode 3 is negative, ions of the X-electrode 4 with the GND potential move toward the Y-electrode to generate the sustain discharge. At that time, it is possible to avoid a failure by setting the A-electrode to the GND potential.

It is preferred that the voltage Vah (Vahr, Vahs) of the variable power source 160′ applied to the A-electrode is higher than the address voltage Va and is a voltage value close to the sustain voltage Vs.

In the embodiment, the address drive section (specifically, the floating address drive section 150 in FIG. 2) is floated, of which the virtual GND is connected to the variable power source (the numeral 160 in FIG. 2). In the rising period of the reset period and in the sustain period, the address drive section is synchronized with the positive pulse application to the Y-electrode voltage to superimpose the power pulse generated in the variable power source on an output voltage of the floating address drive section 150 and then set the superimposed pulse as the A-reset pulse or the A-positive pulse that are applied to the A-electrode. At that time, it is possible to realize a more stable one-side drive by properly varying the voltage value of the variable power source based on the preceding display state.

As described above, in the rising period of the reset period and in the sustain period, the A-reset pulse and the A-positive reset pulse are applied to the A-electrode. However, the present invention is not limited to the configuration, and the configuration may be such that, in only either of the periods, the pulse is applied to the A-electrode.

The present invention is applied to the plasma display device, and, more particularly, the present invention can advantageously be used for stabilization of operations and improvement of the service life of the plasma display device.

What is claimed is:

1. A plasma display device comprising:
a plurality of X-electrodes;
a plurality of Y-electrodes arranged in parallel with the X-electrodes; and
a plurality of address electrodes arranged opposite to the X-electrodes and the Y-electrodes and orthogonal to the X-electrodes and the Y-electrodes;
wherein the X-electrodes are set at the ground potential or a predetermined constant potential;
reset pulses having a positive polarity and a negative polarity are applied to the Y-electrode in the reset period, and sustain pulses having the positive polarity and the negative polarity are applied to the Y-electrode in the sustain period;
a address pulses are applied to the address electrode in the address period, and pulse signals are applied to the address electrode at least either in the reset period or in the sustain period; and
a level of the pulse signal is higher than a level of the address pulse.

2. The plasma display device according to claim 1, wherein the pulse signals are applied in response to the positive reset pulses applied to the Y-electrodes in the reset period.

3. The plasma display device according to claim 1, wherein the pulse signals are applied in response to the positive sustain pulses applied to the Y-electrodes in the sustain period.

4. A plasma display device comprising:
a plurality of the X-electrodes set at the ground potential or a predetermined constant level;
a Y-drive section that supplies pulses to a plurality of the Y-electrodes arranged in parallel with the X-electrodes; and
an address drive section that supplies pulses to a plurality of the address electrodes arranged opposed to the X-electrodes and the Y-electrodes and orthogonal to the X-electrodes and the Y-electrodes;
wherein, in the reset period, the Y-drive section supplies the reset pulses having the positive polarity and the negative polarity, and the address drive section supplies to first pulses to the address electrodes;
in the address period, the Y-drive section supplies scan pulses to the Y-electrodes and the address drive section supplies the address pulses to the address electrodes;
in the sustain period, the Y-drive section supplies the sustain pulses having the positive polarity and the negative polarity, and the address drive section supplies second pulses to the address electrodes; and
levels of the first pulse and/or the second pulse are higher than a level of the address pulse.

5. The plasma display device according to claim 4, wherein the first pulses are applied in response to the positive reset pulses supplied to the Y-electrodes in the reset period.

6. The plasma display device according to claim 4, wherein the second pulses are applied in response to the positive sustain pulses supplied to the Y-electrodes in the sustain period.

7. The plasma display device according to claim 4, wherein the address drive section is floated, and includes a voltage source that supplies a voltage for setting the levels of the first pulse and the second pulse to the floated address drive section.

8. The plasma display device according to claim 7, wherein the voltage source is a variable voltage source, and it is possible to control the levels of the first pulse and/or the second pulse by the variable voltage source.

9. The plasma display device according to claim 4, wherein the levels of first pulse and the second pulse are different from each other.

10. A three-electrode type plasma display device comprising:
a plurality of the X-electrodes;
a Y-drive section that supplies pulses to a plurality of the Y-electrodes arranged in parallel with the X-electrodes; and
an address drive section that supplies pulses to a plurality of the address electrodes arranged opposed to the X-electrodes and the Y-electrodes and orthogonal to the X-electrodes and the Y-electrodes;
wherein:
the X-electrodes are set at the ground potential;
the Y-drive section is constructed to perform Y-sustain;
the address drive section is floated and supplies, in the reset period or the sustain period, higher voltages than address drive voltages to the address electrodes in the address period.

11. The plasma display device according to claim 10, wherein the voltage applied to the address electrodes can be varied in the reset period and in the sustain period respectively.

12. The plasma display device according to claim 11, wherein the voltage applied to the address electrodes can be controlled in response to a display state in the reset period and in the sustain period respectively.
